(19) United States
(12) Patent Application Publication
(10) Pub. No.: US 2017/0246544 A1
(43) Pub. Date: Aug. 31, 2017

(54) VIDEO GAME STREAMING FOR SPECTATING

(71) Applicant: Microsoft Technology Licensing, LLC, Redmond, WA (US)

(72) Inventors: Sharad Agarwal, Seattle, WA (US); Stefan Saroiu, Redmond, WA (US); Alastair Wolman, Seattle, WA (US); Lenin Ravindranath Sivalingam, Redmond, WA (US); Eduardo Cuervo, Bellevue, WA (US); Paramvir Bahl, Bellevue, WA (US); Petko Ivanov Georgiev, Cambridge (GB)

(21) Appl. No.: 15/055,509

(22) Filed: Feb. 26, 2016

(51) Int. Cl. A63F 13/86; A63F 13/537; A63F 13/63; A63F 13/35

(52) U.S. Cl. CPC A63F 13/86; A63F 13/35; A63F 13/537; A63F 13/63

(57) ABSTRACT

A system is provided that allows a spectator to spectate video gameplay over a network. Recorded information associated with a selected recording of a player playing a video game that includes a game engine is received over the network. The recorded information includes game commands that were input to the game engine as the player was playing the game, and inputs the player made to the game to control it. The recorded information is replayed to the game at the timing in which this information was originally recorded, where this replay includes replaying the game commands to the game engine. The replay generates a playback of the selected recording which is displayed on the display screen of the spectator's computer. Upon receiving a request from the spectator to view the inputs the player made to the game they are highlighted on the screen during the playback of the selected recording.

### BACKGROUND

Electronic games are games that employ electronics to create an interactive system with which a user can play. A video game is a type of user-interactive electronic game that runs on a computing device which includes a display device and a user interface. Video gaming has become a global phenomenon. For example, the vast majority of electronic games today are video games. Additionally, video games are currently the third-largest segment in the U.S. entertainment market, behind broadcast television and cable television. Users today play many different types of video games on a wide variety of computing devices including various types of mobile computing devices (such as smartphones, tablet computers, and laptop/notebook personal computers (PCs)) and various types of non-mobile computing devices (such as desktop PCs and various types of video game consoles).

### SUMMARY

One exemplary implementation of the video game streaming technique described herein involves a system for spectating video gameplay over a computer network. This system includes a computing device that is used by a spectator, where this spectator computing device includes a display screen and a video game that is executable by the spectator computing device, and the video game includes a game engine. A request is received from the spectator to spectate a selected video gameplay recording, where this recording is of a player who was playing the video game. This spectation request is then forwarded over the network to a video gameplay repository. Recorded video gameplay information associated with the selected video gameplay recording is then received over the network from the video gameplay repository, where this gameplay information includes each of the high-level game commands that was input to the game engine as the player was playing the video game, and this gameplay information also includes inputs the player made to the video game to control it as they were playing it. The recorded video gameplay information is then replayed to the video game at the timing in which this gameplay information was originally recorded, where this replay includes replaying the high-level game commands to the game engine, and this replay generates a playback of the selected video gameplay recording. The playback of the selected video gameplay recording is then displayed on the display screen. Upon receiving a request from the spectator to view the inputs the player made to the video game to control it, these inputs are highlighted on the display screen during the playback of the selected video gameplay recording.

Other exemplary implementations of the video game stream technique described herein involve a system for cataloging video gameplay, and a system for providing video gameplay assistance over a computer network.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the video game streaming technique implementations described herein will become better understood with regard to the following description, appended claims, and accompanying drawings where:

FIG. 1 is a diagram illustrating an exemplary implementation, in simplified form, of a system framework for realizing the video game streaming technique implementations described herein.

FIG. 2 is a flow diagram illustrating an exemplary implementation, in simplified form, of a process for recording and cataloging video gameplay.

FIGS. 3-5 are a flow diagram illustrating an exemplary implementation, in simplified form, of a process for spectating video gameplay over a computer network.

FIGS. 6 and 7 are a flow diagram illustrating an exemplary implementation, in simplified form, of a process for providing video gameplay assistance over a computer network.

FIG. 8 is a diagram illustrating an exemplary implementation, in simplified form, of a video gameplay replayer computer program for spectating video gameplay over a computer network.

FIG. 9 is a diagram illustrating an exemplary implementation, in simplified form, of a video gameplay cataloger computer program for cataloging video gameplay.

FIG. 10 is a diagram illustrating an exemplary implementation, in simplified form, of a video gameplay assister computer program for providing video gameplay assistance over a computer network.

FIG. 11 is a diagram illustrating a simplified example of a general-purpose computer system on which various implementations and elements of the video game streaming technique, as described herein, may be realized.

### DETAILED DESCRIPTION

In the following description of video game streaming technique implementations (hereafter referred to as streaming technique implementations for simplicity) reference is made to the accompanying drawings which form a part hereof, and in which are shown, by way of illustration, specific implementations in which the streaming technique can be practiced. It is understood that other implementations can be utilized and structural changes can be made without departing from the scope of the streaming technique implementations.

It is also noted that for the sake of clarity specific terminology will be resorted to in describing the streaming technique implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “one version”, or “another version”, or an “exemplary version”, or an “alternate version” means that a particular feature, a particular structure, or particular characteristics described in connection with the implementation or version can be included in at least one implementation of the streaming technique. The appearances of the phrases “in one implementation”, “in another implementation”, “in an exemplary implementation”, “in an alternate implementation”, “in one version”, “in another version”, “in an exemplary version”, and “in an alternate version” in various places in the specification are not necessarily all referring to the same implementation or version, nor are separate or alternative implementations/versions mutually exclusive of other implementations/versions. Yet furthermore, the order of process flow representing one or more implementations or versions of the streaming technique does not inherently indicate any particular order nor imply any limitations of the streaming technique.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

### 1.0 Video Games and Game Engines

The term “video game” is used herein to refer to a user-interactive electronic game application that is executed on (e.g., runs on) a computing device which includes a display device and a user interface. As such, the terms “video game” and “video game application” may be used interchangeably herein. As described heretofore, users today play many different types of video games on a wide variety of conventional computing devices including various types of mobile computing devices (such as smartphones, tablet computers, and laptop/notebook personal computers (PCs), among others) and various types of non-mobile computing devices (such as desktop PCs and various types of video game consoles, among others).

As is appreciated in the art of video games, modern video games are commonly built on top of a game engine that provides a flexible and reusable software framework which supports the efficient creation and development of the video games. In other words and as will be described in more detail hereafter, a game engine provides an integrated video game development environment that enables simplified, rapid development of video games in a data-driven manner. A game engine commonly separates game-specific content (e.g., artwork, levels, characters, weapons, and the like) from core gaming functionality (e.g., rendering, physics, user input handling, animation, artificial intelligence, networking, streaming, memory management, threading, and localization support). The same game engine can be reused/adapted to create many different video games. A game engine can also make it easier to port a given video game to different types of software environments (also known as target platforms). Many different game engines exist today, most of which support a plurality of different computer operating environments. Exemplary conventional game engines that are currently popular for fast-action games include UNREAL ENGINE® (a registered trademark of Epic Games, Inc.), UNITY® (a registered trademark of Unity IPR APS, LLC), ID TECH® (a registered trademark of id Software, LLC), and MT FRAMEWORK® (a registered trademark of Capcom Co., LTD), among many others.

Video game developers may use a given game engine to create/develop a given video game for various types of computing devices (such as the aforementioned types of mobile and non-mobile computing devices, among other types of computing devices) and various types of software environments. The game engine generally provides a set of core functionality that the video game developers may use to reduce the time, complexities, costs and other burdens associated with developing the video game. The set of core functionality provided by the game engine commonly includes a rendering engine that is responsible for generating the two-dimensional (2D) and/or three-dimensional (3D) graphics associated with the video game, a physics engine that is responsible for giving the video game a realistic sense of the laws of physics in the video game (e.g., detecting and responding to collisions that occur during gameplay), and an audio engine that is responsible for generating sounds that are associated with the video game. The set of core functionality also commonly includes scripting, animation, artificial intelligence, networking, streaming, memory management, threading, and localization support functionality. The set of core functionality also commonly includes functionality that provides a scene graph, which is an object-oriented representation of the video game world. Scene graphs are advantageous in that their use often simplifies the video game design process, and they can be used to more efficiently render vast and complex virtual worlds.

### 2.0 Video Game Streaming for Spectating

As is appreciated in the art of computing devices, today's conventional mobile and non-mobile computing devices include a powerful central processing unit (CPU) and graphics processing unit (GPU) along with a high resolution display screen that is often touch-sensitive. As a result, video gaming (e.g., the execution and playing of video games) has become a very popular activity that users perform on their mobile and non-mobile computing devices. In fact, video gaming is one of the most popular activities that users perform on mobile computing devices today. For example, recent studies estimate that almost half of all mobile computing device users play video games, and these users play video games approximately half of the total time they spend using their mobile computing devices. Additionally and as described heretofore, many users also play video games on various types of conventional non-mobile computing devices.

The term “spectate” is used herein to refer to the act of one or more users watching one or more other users play (e.g., interact with) a video game. Accordingly, the term “spectator” is sometimes used herein to refer to a given user who is watching one or more other users play a video game either live or after-the-fact (e.g., in a prerecorded manner). The term “player” is sometimes used herein to refer to a given user who is playing a given video game. As is appreciated in the art of video games, the term “video gameplay” (hereafter sometimes simply referred to as gameplay) refers to the specific way in which one or more players play a given video game.

Coincident with the aforementioned fact that video gaming has become a global phenomenon, video game spectating has become a very popular activity across the globe. For example, a recent study found that users across the globe spent 2.4 billion hours watching other users play video games in 2013, which is nearly double the amount of time users across the globe spent watching other users play video games in 2012. While some of this video game spectating occurs live in a stadium-type setting, a vast majority of it occurs online (e.g., over the Internet) either live or after-the-fact. In this later case of online video game spectating, the video gameplay is generally streamed over the Internet to individual client computing devices that are being used by each of the spectators. There are many reasons why a user would want to watch one or more other users play a video game. For example, a given player may be an expert at playing the video game, or they may be a celebrity—in either case the spectators may simply enjoy watching the player's video gameplay. The spectators may also be looking for hints/tips and/or techniques on how to play certain portions of the video game. More particularly, in the case where a certain level in the video game is particularly challenging, a given spectator who is stuck at this level may want to watch how other players successfully completed the level. Additionally, the spectators may want to watch a player who has gained a significant achievement in the video game (such as the maximum score in a given level in the video game, among other types of achievements) brag about or otherwise discuss various aspects about their achievement.

The streaming technique implementations described herein are generally applicable to the recording and cataloging of video gameplay, the spectating of video gameplay over a computer network (herein also referred to as a data communication network), and providing video gameplay assistance over the network. The streaming technique implementations are advantageous for various reasons including, but not limited to, the following. As will be appreciated from the more-detailed description that follows, the streaming technique implementations significantly reduce the amount of network bandwidth, storage space, and processing that are consumed by the just-described spectating. In other words, the streaming technique implementations minimize the network traffic associated with delivering video gameplay to spectators at an acceptable frame rate and with high visual quality. As such, the streaming technique implementations provide for significantly faster upload of video gameplay from the players' computing devices and significantly faster download of video gameplay to spectators' computing devices. The streaming technique implementations also provide both players and spectators with a cost savings when their computing devices are operating over a costed (e.g., metered) network connection. Additionally, the streaming technique implementations may be realized on both mobile and non-mobile computing devices, and heterogeneous combinations thereof, where the operating characteristics of each of these computing devices (e.g., the particular type and speed of the CPU that is employed in each computing device, the particular type and speed of the GPU that is employed in each computing device, the particular resolution and aspect ratio of the display screen that is employed in each computing device, and other runtime constraints of each computing device) may be different.

The streaming technique implementations described herein are further advantageous in that they may be realized on a wide variety of video games. For example, the streaming technique implementations may be realized on video games that include a wide variety of underlying game engines, and video games that do not include an underlying game engine. The streaming technique implementations may also be realized on video games that run in a wide variety of different computer operating environments. For example, in a tested implementation the streaming technique described herein was realized on the Tentacles: Enter the Dolphin video game which employs the UNITY® (a registered trademark of Unity IPR APS, LLC) game engine and runs in the ANDROID® (a registered trademark of Google Inc.) mobile operating system environment.

The streaming technique implementations described herein are further advantageous in that they utilize the full graphics capability of each spectator computing device and thus maximize the quality (e.g., the frame rate and resolution) of the video gameplay each spectator is viewing. The streaming technique implementations also provide each spectator with a faithful replay of the original video gameplay (e.g., the physics and speed of the original video gameplay are faithfully reproduced on each spectators computing device). The streaming technique implementations also provide each spectator with a rich set of features that allow them to easily and efficiently analyze the details of the video gameplay they are spectating. For example, the streaming technique implementations allow each spectator to see the various player actions that resulted in the video gameplay as it is occurring, thus allowing the spectator to see how the player accomplished the gameplay. The streaming technique implementations also elevate the social networking experience for both players and spectators. Certain ones of the streaming technique implementations also consume significantly less cloud resources (e.g., cloud storage and computing resources). The streaming technique implementations can also be used to efficiently (e.g., compactly) embed video gameplay tutorials into a given video game using far less data than is associated with embedding video of the gameplay tutorials.

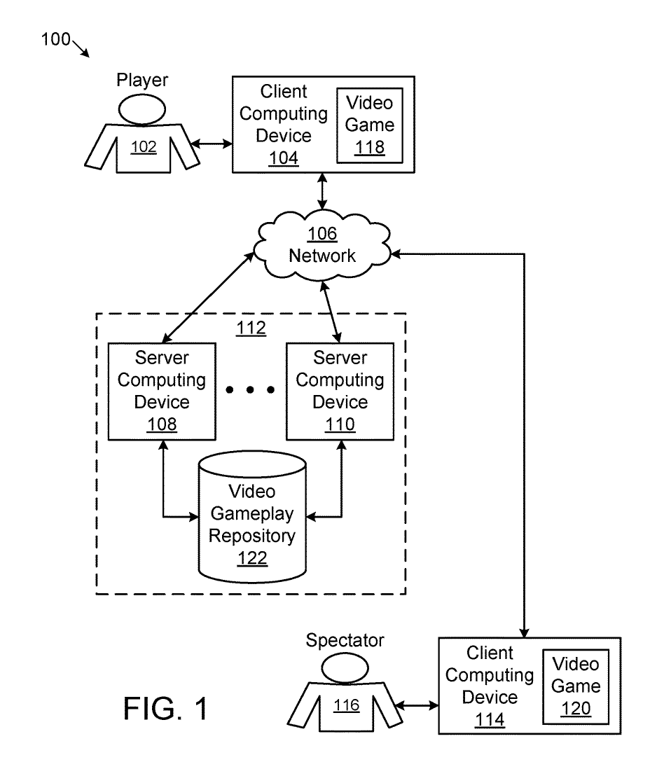

FIG. 1 illustrates an exemplary implementation, in simplified form, of a system framework for realizing the streaming technique implementations described herein. As exemplified in FIG. 1 the system framework 100 includes a client computing device 104 that is used by a player 102 to play a video game 118 that is executed on the device 104. In an exemplary implementation of the streaming technique described herein the client computing device 104 can be any type of conventional mobile computing device (including, but not limited to the types described heretofore) or any type of conventional non-mobile computing device (including, but not limited to the types described heretofore). The client computing device 104 is configured to communicate over a conventional data communication network 106 such as the Internet (among other types of conventional networks) with a cloud service 112 that operates on one or more server computing devices 108/110 that communicate with a video gameplay repository 122 which stores a catalog of indexed video gameplay recordings. The server computing devices 108/110 and video gameplay repository 122 may be remotely located from the device 104, and may also be remotely located from each other. The server computing devices 108/110 can also communicate with each other via the network 106. The term “cloud service” is used herein to refer to a web application that operates in the cloud and can be hosted on (e.g., deployed at) a plurality of data centers that can be located in different geographic regions (e.g., different regions of the world). As will be described in more detail hereafter, the cloud service 112 generally provides various types of functionality associated with the indexing, storage and analysis of recorded video gameplay information that is received from the player's 102 computing device 104.

Referring again to FIG. 1, the system framework 100 also includes another client computing device 114 that is used by a spectator 116 to spectate the gameplay of a video game 120 over the data communication network 106. Similar to the just-described client computing device 104, the client computing device 114 can be any type of conventional mobile computing device or any type of conventional non-mobile computing device, and the device 114 can be either the same as or different than the device 104. The client computing device 114 is also configured to communicate over the data communication network 106 with the cloud service 112. As exemplified in FIG. 1, the video game 120 whose gameplay is being spectated is executed on the client computing device 114. In one implementation of the streaming technique described herein where the spectator 116 is spectating either the player's 102 gameplay of the video game 118 or a different player's (not shown) gameplay of the video game 118, the video game 120 that is executed on the client computing device 114 is the same as the video game 118. In another implementation of the streaming technique where the spectator 116 is spectating the gameplay of another video game that is different than the video game 118, the video game 120 that is executed on the client computing device 114 is this other video game. In addition to the aforementioned recorded video gameplay information indexing, storage and analysis functionality, and as will be described in more detail hereafter, the cloud service 112 also generally provides various types of functionality associated with transmitting selected recorded video gameplay information over the network 106 to the spectator's 116 computing device 114. The cloud service 112 may also provide a gameplay assistance service (not shown) to the player 102 and the spectator 116.

Referring again to FIG. 1, the streaming technique implementations described herein assume that the video game 118 that is executed on the player's 102 computing device 104 has been modified to include appropriate instrumentation that allows the player's 102 video gameplay to be recorded by capturing and recording selected video gameplay information as the player 102 is playing the video game 118. Exemplary types of video gameplay information that can be captured and recorded by the streaming technique implementations as the player is playing the video game 118 are described in more detail hereafter. The streaming technique implementations further assume that the video game 120 that is executed on the spectator's 116 computing device 114 has also been modified to include appropriate instrumentation that allows a selected video gameplay recording to be replayed to the spectator 116 by replaying the recorded video gameplay information that is associated with the recording through the video game 120. The just-described video game 118/120 modifications can be made to any video game and can be realized in a variety of ways. By way of example but not limitation, in an exemplary implementation of the streaming technique that is described in more detail hereafter where the video game 118/120 includes an underlying game engine as described heretofore, the just-described instrumentation can be incorporated into the game engine in a manner that allows each of the high-level game commands that is input to the game engine of the video game 118 as the player 102 is playing it to be captured and recorded, and also allows a given video gameplay recording in the video gameplay repository 122 to be replayed to the spectator 116 by replaying the recorded high-level game commands and other selected video gameplay information that was recorded as the player 102 was playing the video game 118 to the game engine of the video game 120. In another implementation of the streaming technique one or more application programming interfaces (APIs) can be provided to the developer of the video game 118/120 that allow the developer to control how the instrumentation is realized.

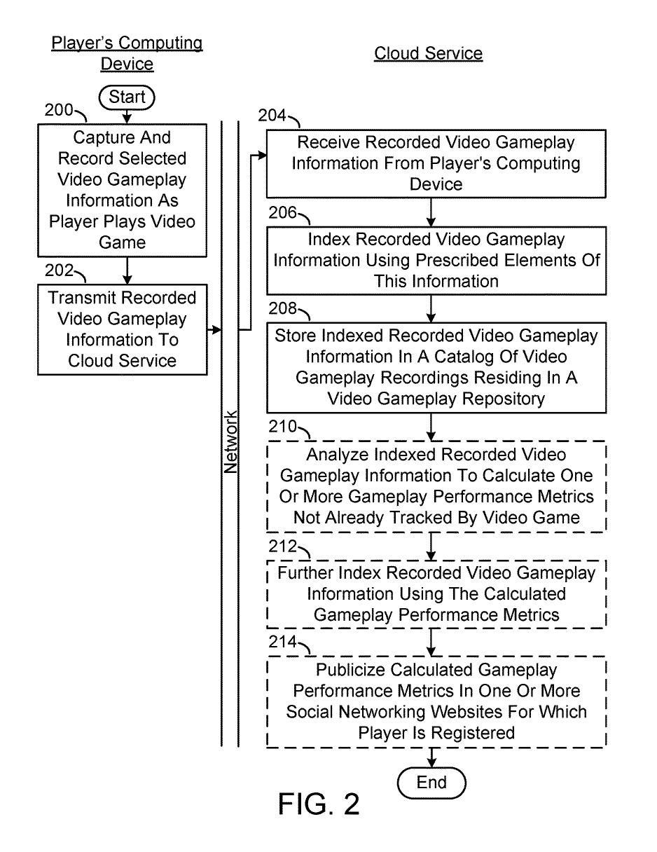

FIG. 2 illustrates an exemplary implementation, in simplified form, of a process for recording and cataloging video gameplay. In an exemplary implementation of the streaming technique described herein the process illustrated in FIG. 2 is realized on the system framework 100 illustrated in FIG. 1, and assumes that the player 102 is actively playing the video game 118 on their client computing device 104 (which is hereafter sometimes simply referred to as the player's computing device). As exemplified in FIG. 2, the process starts with the player's computing device capturing and recording selected video gameplay information as the player is playing the video game (process action 200). In an exemplary implementation of the streaming technique this recording action 200 includes relating the selected video gameplay information to selected timing information in the video game during the capture and recording of this information. In an exemplary implementation of the streaming technique this selected timing information includes, but is not limited to, the current wall-clock time in the video gameplay (e.g., how much time has elapsed since the player started playing the video game), the current frame rate in the video gameplay, and the current frame count in the video gameplay (e.g., how many frames have elapsed since the player started playing the video game).

The streaming technique implementations described herein allow many different types of video gameplay information to be captured and recorded, where some types of information are game-specific, and other types of information are generic and thus applicable to any type of video game. The particular types of video gameplay information that are recorded are determined by the design of the aforementioned instrumentation that is included in the video game. Generally speaking and as will be appreciated from the more detailed description that follows, the streaming technique implementations capture and record just video gameplay information that is non-deterministic (e.g., just video gameplay data that introduces non-determinism during the video gameplay). As is appreciated in the arts of computing and philosophy, the term “non-deterministic” refers to behavior that is unpredictable. The streaming technique implementations do not capture or record video gameplay information that is deterministic in order to reduce the amount of network bandwidth, storage space, and processing that are consumed by the recording, cataloging and spectating of video gameplay.

Exemplary types of video gameplay information that may be captured and recorded by the streaming technique implementations described herein will now be described in more detail. In the case where the video game includes an underlying game engine, the streaming technique implementations will capture and record each of the high-level game commands that is input to the game engine as the player is playing the video game. The streaming technique implementations may also capture and record the name of the video game, the name of the player, the level in the video game that the player started their video gameplay in, the level in the video game that the player finished their gameplay in, the time duration of the player's gameplay, the total number of points awarded to the player during their gameplay, other achievements awarded to the player during their gameplay (e.g., the number of gold coins awarded, specific achievement badges awarded, and the like), the position in the video game where the player started their gameplay, and the position in the video game where the player finished their gameplay (e.g., the player started their gameplay in room A and ended in room C).

The streaming technique implementations may also capture and record the inputs the player makes to the video game to control it as they are playing it. By way of example but not limitation, in the case where the player's computing device includes a display screen that is touch-sensitive, the video gameplay information that is captured and recorded may include touch gestures (e.g., swipes, and the like) that the player makes on the display screen. In the case where the player's computing device includes a physical keyboard that is connected to the computing device, the video gameplay information that is captured and recorded may include data from the keyboard (such as key presses that the player makes on the keyboard to control the video game). In the case where the player's computing device includes a game controller that is connected to the computing device (where the controller may include one or more buttons, or one or more joysticks, or one or more D-pads (also known as directional pads), among other types of player control elements, or any combination thereof), the video gameplay information that is captured and recorded may include data from the controller (such as one or more of button presses that the player makes on the controller to control the video game, or joystick movements that the player makes on the controller to control the game, or D-pad presses that the player makes on the controller to control the game). In the case where the player's computing device, or the keyboard, or the game controller, or any combination thereof, includes one or more motion sensors (such as an accelerometer, or a gyroscope, among other types of motion sensors) that are integrated into the device/keyboard/controller, the video gameplay information that is captured and recorded may include data from these motion sensors. In the case where the player's computing device includes a mouse or trackpad that is connected to the computing device (where the mouse or trackpad may include one or more buttons), the video gameplay information that is captured and recorded may include data from the mouse or trackpad.

The streaming technique implementations described herein may also capture and record the current seeds to one or more random number generators that are employed in the video game. As is appreciated in the art of video games, random number generators are often used in a video game to determine the movement of certain graphical elements (e.g., enemies, and the like) in the game. The streaming technique implementations may also capture and record the current wall-clock time and the current frame count. As is also appreciated in the art of video games, wall-clock time is sometimes used in a video game to seed a random number generator or change the behavior of the game (e.g., the game behavior and what is displayed to the player may change based on the current time of day). The streaming technique implementations may also capture and record updates to movable objects in the video game that are device-performance-specific—as is also appreciated in the art of video games, such updates are referred to as fixed updates in the UNITY® (a registered trademark of Unity IPR APS, LLC) game engine. The streaming technique implementations may also capture and record updates to movable objects in the video game that are time-specific—as is also appreciated in the art of video games, such updates are referred to as periodic updates in the UNITY® (a registered trademark of Unity IPR APS, LLC) game engine. The streaming technique implementations may also capture and record updates to coroutines that are employed in the video game, and updates to a physics engine that is employed in the video game.

The streaming technique implementations described herein may also capture and record information specifying the player's current physical location as they are playing the video game. As is also appreciated in the art of video games, a video game may change its behavior and what is displayed to the player based on their current physical location. The streaming technique implementations may also capture and record information specifying certain capabilities of the player's computing device such as the resolution and aspect ratio of its display screen, among other capabilities. In the case where the player's computing device includes one or more audio input devices (such as a microphone, or the like), the video gameplay information that is captured and recorded may include data from the audio input devices as the player is playing the video game (e.g., the video gameplay information may include commentary from the player as they are playing the video game). In the case where the player's computing device includes one or more video input devices (such as a video camera, or the like), the video gameplay information that is captured and recorded may include data from the video input devices as the player is playing the video game (e.g., the video gameplay information may include the player's facial expressions as they are playing the video game). As is also appreciated in the art of video games, data from a video input device is sometimes used in a video game to determine one or more characteristics of the player's current physical environment (e.g., if the player is currently indoors or outdoors, or the current light level in the player's current physical environment, among other characteristics), and the behavior of the game may change based on these determined characteristics.

As is also appreciated in the art of video games, a video game may routinely write information to (e.g., store information in) and read information from the file system on the player's computing device (hereafter sometimes simply referred to as the player's file system) as they are playing the video game. For example, the video game may routinely write the player's current in-game abilities to their file system, and these abilities often determine the player's in-game capabilities (such as the moves they are allowed to make or the powers they have) in a given level in the video game. Whenever the player resumes their playing of the video game, the game reads the player's current in-game abilities from their file system so that they have the same in-game capabilities as they had when they last played the game. The streaming technique implementations described herein may also capture and record each item of information that is read from the file system on the player's computing device as they are playing the video game. The streaming technique implementations may also capture and record each item of information that is both read from and written to the file system on the player's computing device as they are playing the video game. At any given point in time information in the player's file system may be quite different than information in a given spectator's file system (e.g., the spectator's current in-game abilities might be different than those of the player). The just-described capture and recording of information that is read from and written to the player's file system is advantageous since allows the player's in-game capabilities to be duplicated on each spectator's computing device whenever they are spectating the player's video gameplay over a computer network using the streaming technique implementations. The streaming technique implementations may also perform an historical analysis of the player's file system in order to determine which files in the file system are modified by the video game, and then information related to just these files may be captured and recorded (e.g., the sprite-related and text-related game files for a typical video game generally do not change while the video game is being played).

Referring again to FIG. 2, the player's computing device transmits the recorded video gameplay information over the network to the aforementioned cloud service (process action 202). In an exemplary implementation of the streaming technique described herein this transmission action 202 includes compressing the recorded video gameplay information and then transmitting the compressed recorded video gameplay information over the network to the cloud service. In an alternate implementation of the streaming technique the recorded video gameplay information is transmitted to the cloud service uncompressed. Regardless of whether or not the recorded video gameplay information is compressed, since the amount of data associated with this information is significantly smaller than the amount of data associated with a video recording of the gameplay, actions 200 and 202 advantageously enhance the operation of the player's computing device and the server computing devices by reducing network bandwidth usage and by providing faster communication between the player's computing device and the server computing devices. Upon receiving the recorded video gameplay information transmitted from the player's computing device (process action 204), the cloud service indexes the recorded video gameplay information using prescribed elements of this information (process action 206)—in other words, the recorded video gameplay information may be labeled with prescribed elements of the recorded video gameplay information. It will be appreciated that the recorded video gameplay information may be indexed in many different ways. In an exemplary implementation of the streaming technique the recorded video gameplay information is indexed by one or more of the name of the video game that is being played, the name of the player who is playing the video game, the player's current physical location as they are playing the video game, the level in the video game that the player started their gameplay in, the level in the video game that the player finished their gameplay in, the time duration of the gameplay, the total number of points the player was awarded during the gameplay, other achievements the player was awarded during the gameplay, a thumbnail image that represents the gameplay, the player's starting and ending positions in the gameplay, and the aforementioned capabilities of the player's computing device. The cloud service then stores the indexed recorded video gameplay information in a catalog of video gameplay recordings that resides in the aforementioned video gameplay repository (process action 208). As will be described in more detail hereafter, a given spectator may browse this catalog of video gameplay recordings in order to find particular video gameplay recordings that they are interested in, and then select a desired video gameplay recording for replay on the spectator's computing device.

Referring again to FIG. 2, once the indexed recorded video gameplay information has been stored in the cloud service's video gameplay repository (action 208), the cloud service can process this gameplay information in various ways. By way of example but not limitation, the cloud service can optionally analyze (e.g., inspect) the indexed recorded video gameplay information to calculate one or more gameplay performance metrics that are not already tracked by the video game (process action 210), and the cloud service can then further [additionally] index the recorded video gameplay information using these calculated gameplay performance metrics (process action 212)—in other words, the recorded video gameplay information may be further labeled with each of the calculated gameplay performance metrics. The cloud service can optionally also publicize the calculated gameplay performance metrics in one or more social networking websites for which the player is registered (process action 214).

As is also appreciated in the art of video games, video games commonly maintain a current game score for each player and display this score to the player as they are playing the games. For a given video game that is being played by a given player, the current game score might be based on how many enemies the player has killed, among other video gameplay factors. However, besides the current game score, there are various other gameplay performance metrics that may not be tracked by the video game but may be of interest to both the player and spectators. The streaming technique implementations described herein can calculate many different types of such metrics. By way of example but not limitation, the streaming technique implementations can calculate the number of swipes per prescribed unit of time (e.g., per second, or per minute, among other units of time) the player made on the touch-sensitive display screen of a computing device, or the number of enemy kills the player made per prescribed unit of time.

The streaming technique implementations described herein can also calculate the number of adjunct gameplay moves the player made per prescribed unit of time. For example, in the conventional CROSSY ROAD™ (a trademark of Hipster Whale Pty Ltd.) mobile video game the player has to move forward in order to cross a very busy road; the player is able to move forward, backward, leftward or rightward, but ultimately the player has to keep moving forward in order to get to the other side of the road. In this mobile video game the player that makes the smallest number of non-forward moves may be considered to be an expert player. Similarly, in other video games the player may be allowed to “undo” their gameplay moves—the player that has performed the smallest number of “undos” may be considered to be an expert player. As will be appreciated from the more detailed description that follows, a spectator may consider the just-described adjunct gameplay moves metric, along with any of the other metrics described herein, when they select a video gameplay recording to spectate.

The streaming technique implementations described herein can also identify certain types of “fancy” gameplay moves that are difficult for the player to make (e.g., a jump onto a high object, or an impressive back-kick or flip, or how many back-flips the player successfully completed while killing an enemy); such moves are sometimes referred to as special moves in the art of video games. The streaming technique implementations can also identify certain ancillary factors that are related to the video gameplay (e.g., whether or not the player was jogging while they successfully completed a given level in the video game and if so, the average speed at which they were jogging).

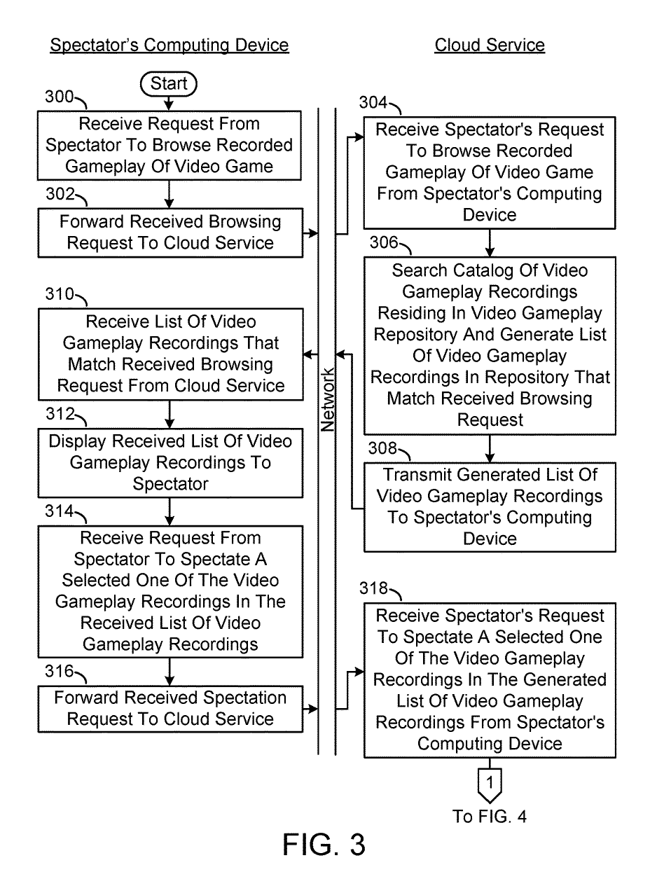

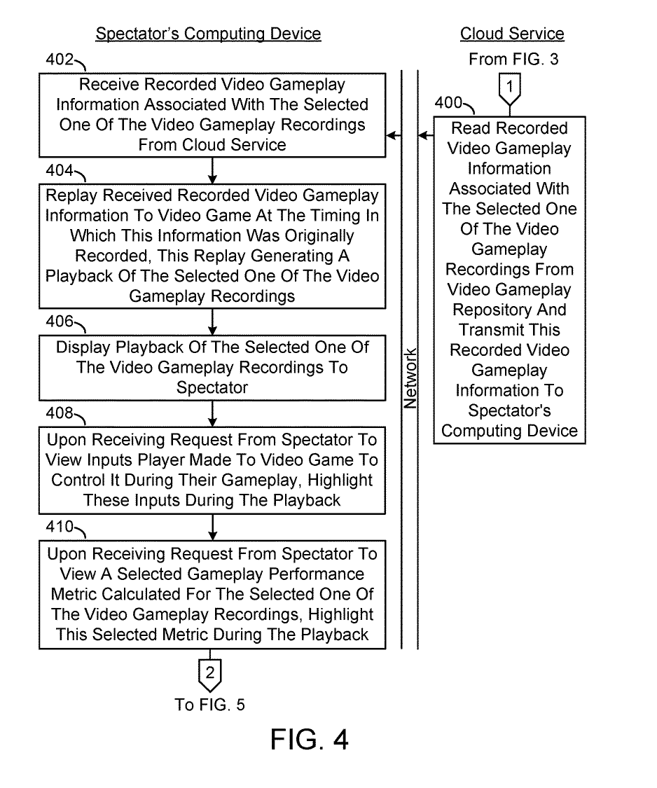

FIGS. 3-5 illustrate an exemplary implementation, in simplified form, of a process for spectating video gameplay over a computer network. In an exemplary implementation of the streaming technique described herein the process illustrated in FIGS. 3-5 is realized on the system framework 100 illustrated in FIG. 1, and assumes that the spectator 116 is using their client computing device 114 (which is herein sometimes simply referred to as the spectator's computing device) to spectate, over the data communications network 106, recorded gameplay of the video game 120 that is executed on the device 114. As exemplified in FIG. 3, the process starts with the spectator's computing device receiving a request from the spectator to browse recorded gameplay of the video game (process action 300), where this browsing request includes information specifying the attributes of the recorded gameplay that the spectator is interested in spectating. In an exemplary implementation of the streaming technique described herein the attributes of the recorded gameplay that are specified in the sectator's browsing request include the name of the video game. These attributes may also include one or more other types of information such as the resolution and aspect ratio of the display screen that is employed in the spectator's computing device (hereafter simply referred to as the spectator's display screen), a specific level in the video game, the name of a specific player, one or more social networking attributes (such as a certain number of likes, a certain number of views, a certain number of comments, and/or a certain number of replies, among other types of social networking attributes), and the like.

Referring again to FIG. 3, after the spectator's computing device has received the spectator's request to browse recorded gameplay of the video game (action 300), the spectator's computing device forwards this browsing request over the network to the cloud service (process action 302). Upon receiving the spectator's request to browse recorded gameplay of the video game from the spectator's computing device (process action 304), the cloud service searches the aforementioned catalog of video gameplay recordings that resides in the video gameplay repository and generates a list of the video gameplay recordings in the video gameplay repository that match this browsing request (process action 306). More particularly, the cloud service generates a list of the video gameplay recordings in the video gameplay repository that match the aforementioned video gameplay attributes that were specified by the spectator. For example, in the case where these attributes include the resolution and aspect ratio of the spectator's display screen, this list will include just the video gameplay recordings in the video gameplay repository that have this resolution and aspect ratio. In the case where the attributes include a specific level in the video game, the list will include just the video gameplay recordings in the video gameplay repository that include this specific level. In the case where the attributes include the name of a specific player, the list will include just the video gameplay recordings in the video gameplay repository where the specific player was playing the video game.

Referring again to FIG. 3, after the cloud service has generated the list of the video gameplay recordings in the video gameplay repository that match the spectator's request to browse recorded gameplay of the video game (action 306), the cloud service transmits this list of video gameplay recordings over the network to the spectator's computing device (process action 308). Upon receiving this list of video gameplay recordings from the cloud service (process action 310), the spectator's computing device displays the received list on the display screen of the spectator's computing device (process action 312). It is noted that when the cloud service transmits the list of the video gameplay recordings in the video gameplay repository that match the spectator's browsing request to the spectator's computing device (action 308), the cloud service may also transmit the aforementioned gameplay performance metrics that were calculated for each of the video gameplay recordings in this list to the spectator's computing device. Then, when the spectator's computing device displays the received list on the display screen of the spectator's computing device (action 312), the spectator's computing device may also display the gameplay performance metrics that were calculated for each of the video gameplay recordings in the list, thus allowing the spectator to consider these metrics during their video gameplay recording selection.

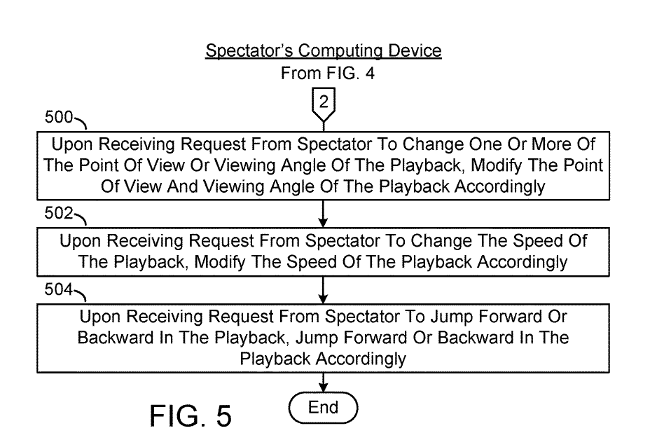

Referring again to FIG. 3 and as exemplified in FIG. 4, upon the spectator's computing device receiving a request from the spectator to spectate a selected one of the video gameplay recordings in the received list (process action 314), the spectator's computing device forwards this spectation request over the network to the cloud service (process action 316). Upon receiving the spectator's request to spectate a selected one of the video gameplay recordings in the list of video gameplay recordings that match the spectator's browsing request (process action 318), the cloud service reads the recorded video gameplay information that is associated with the selected one of the video gameplay recordings from the video gameplay repository, and transmits this recorded video gameplay information over the network to the spectator's computing device (process action 400). The spectator's computing device then receives this recorded video gameplay information from the cloud service (process action 402). Since the amount of data associated with the recorded video gameplay information received from the cloud service is significantly smaller than the amount of data associated with a video recording of the gameplay, actions 400 and 402 advantageously enhance the operation of the server computing devices and the spectator's computing device by reducing network bandwidth usage and by providing faster communication between the server computing devices and the spectator's computing device. In the aforementioned case where the received recorded video gameplay information is compressed, this reception action 402 includes decompressing the received recorded video gameplay information.

Referring again to FIG. 4, upon receiving the recorded video gameplay information transmitted from the cloud service (action 402), the spectator's computing device replays (e.g., plays back) the received recorded video gameplay information to the video game at the timing in which the video gameplay information was originally recorded, where this replay generates a playback (e.g., a rendering) of the selected one of the video gameplay recordings that the spectator requested to spectate (process action 404). The spectator's computing device then displays this playback on the display screen of the spectator's computing device (process action 406). In an exemplary implementation of the streaming technique described herein the replay of the received recorded video gameplay information to the video game (action 404) is realized as follows. The replay is performed in an isolated manner so that in the case where the spectator was playing the video game at the time they submitted their request to spectate a selected one of the video gameplay recordings in the received list, the replay of the recorded video gameplay information to the video game does not affect the current state of the spectator's gameplay. For example, the replay is prevented from writing to the file system on the spectator's computing device, thus insuring that the current state of the spectator's gameplay (e.g., their current level in the video game, current game achievements, and the like) is not modified by the replay. In the case where the video game includes an underlying game engine and the recorded video gameplay information includes the high-level game commands that were input to the game engine as the player was playing the video game, certain ones of the recorded high-level game commands are replayed to the game engine relative to the current wall-clock time in the recorded video gameplay, while other ones of the recorded high-level game commands are replayed to the game engine relative to the current frame count in the recorded video gameplay. In the case where the spectator's computing device is either slower or faster than the player's computing device, prescribed elements of the recorded video gameplay information (e.g., the aforementioned updates to movable objects in the video game that are device-performance-specific, and the current frame rate of the video game) may be used to adjust the speed of the replay. In the case where the spectator's request to browse recorded gameplay of the video game specified a specific level in the video game, the replay is started at this specific level. Each random number generator call is intercepted and the current seed to the random number generator in the recorded video gameplay information is provided to this call. Each wall-clock time call is intercepted and the current wall-clock time in the recorded video gameplay information is provided to this call.

Referring again to FIGS. 3 and 4, in the case where the spectator is playing the video game live when they submit their aforementioned request to spectate the selected one of the video gameplay recordings (action 314), the playback of the selected one of the video gameplay recordings can be displayed to the spectator (action 406) in various ways. For example, in one implementation of the streaming technique described herein, the playback of the selected one of the video gameplay recordings can be displayed in place of the spectator's live video gameplay. In another implementation of the streaming technique the playback of the selected one of the video gameplay recordings can be displayed as a semi-transparent overlay layer on top of the spectator's live video gameplay. In yet another implementation of the streaming technique the playback of the selected one of the video gameplay recordings can be displayed alongside (e.g., either to the left of, or to the right of, or above, or below) the spectator's live video gameplay. In an exemplary realization of the just-described implementations where the playback of the selected one of the video gameplay recordings is displayed either on top of or alongside the spectator's live video gameplay, this playback may be automatically synchronized to the spectator's live video gameplay and may also be automatically adapted to the current point of view and viewing angle of the spectator's live video gameplay.

Referring again to FIG. 4 and as will now be described in more detail, the spectator can modify the playback of the selected one of the video gameplay recordings that they requested to spectate in various ways on demand (e.g., at will) during its playback. The spectator can also view various types of additional information about this video gameplay recording on demand during the playback. By way of example but not limitation, in the case where the received recorded video gameplay information includes the inputs the player made to the video game to control it during their gameplay, the spectator can be provided with a user interface that allows them to submit a request to view these inputs on their display screen during the playback. Upon the spectator's computing device receiving a request from the spectator to view the inputs the player made to the video game to control it during their gameplay, the spectator's computing device will highlight these inputs on its display screen during the playback of the selected one of the video gameplay recordings (process action 408). More particularly and by way of example but not limitation, in the case where the recorded player inputs include touch gestures that the player made on a touch-sensitive display screen as they were playing the video game, these touch gestures may be highlighted on the on the display screen of the spectator's computing device during the playback of the selected one of the video gameplay recordings, thus showing the spectator where the player's finger(s) was positioned and how it moved during the gameplay. In an exemplary implementation of the streaming technique described herein this touch gesture highlighting is realized by displaying an outline of the current position of the player's finger(s) on the display screen and a fading trail indicating the previous positions of the player's finger(s). In the case where the recorded player inputs include key presses that the player made on a physical keyboard as they were playing the video game, these key presses may be highlighted on the on the display screen of the spectator's computing device during the playback of the selected one of the video gameplay recordings. In the case where the recorded player inputs include one or more of button presses, or joystick movements, or D-pad presses that the player made on a game controller as they were playing the video game, these button presses, joystick movements, or D-pad presses may be highlighted on the on the display screen of the spectator's computing device during the playback of the selected one of the video gameplay recordings. Given the foregoing, it will be appreciated that action 408 serves to increase spectator efficiency since it allows the spectator to see how the player accomplished the gameplay.

Referring again to FIG. 4, in the case where the cloud service calculated one or more gameplay performance metrics for the selected one of the video gameplay recordings that the spectator requested to spectate, the spectator can be provided with a user interface that allows them to select the type(s) of gameplay performance metrics they want to view on their display screen during the playback. Upon the spectator's computing device receiving a request from the spectator to view a selected one of the gameplay performance metrics, the spectator's computing device will highlight this selected metric on its display screen during the playback of the selected one of the video gameplay recordings (process action 410).

The just-described ability for the spectator to highlight selected types of inputs the player made to the video game during the playback of the selected one of the video gameplay recordings is advantageous since it shows the spectator how the player achieved the gameplay (e.g., how the player got a character in the video game to make the moves shown in the gameplay). It will be appreciated that the highlighting of the selected types of player inputs can be realized in various ways. In an exemplary implementation of the streaming technique described herein the highlighting of the selected types of player inputs is realized by displaying each of the different selected types of player inputs as a semi-transparent overlay layer on top of the playback of the selected one of the video gameplay recordings. The highlighting of the gameplay performance metrics can also be realized by displaying them as another semi-transparent overlay layer on top of this playback.

As exemplified in FIG. 5, the spectator can also be provided with a user interface that allows them to change the point of view and viewing angle of the playback of the recorded video gameplay. Upon the spectator's computing device receiving a request from the spectator to change one or more of the point of view or viewing angle of the playback, the spectator's computing device will modify the point of view and viewing angle of the playback accordingly (process action 500). In the case where the video game includes an underlying game engine that includes a rendering engine which is responsible for generating the 2D and/or 3D graphics associated with the video game, the streaming technique implementations described herein can modify the point of view and viewing angle of the playback by inputting a command that specifies this modification to the game engine. The spectator can also be provided with a user interface that allows them to pause and resume the playback, change the speed of the playback (e.g., either speed it up or slow it down), and jump forward and backward in the playback. Upon the spectator's computing device receiving a request from the spectator to change the speed of the playback, the spectator's computing device will modify the speed of the playback accordingly (process action 502). Upon the spectator's computing device receiving a request from the spectator to jump forward or backward in the playback, the spectator's computing device will jump forward or backward in the playback accordingly (process action 504). It will be appreciated that the just-described ability to pause and resume the playback of the recorded video gameplay is advantageous since after pausing the playback at a desired point in the recording, the spectator can add a social networking comment about the current screen or gameplay move that the player just made.

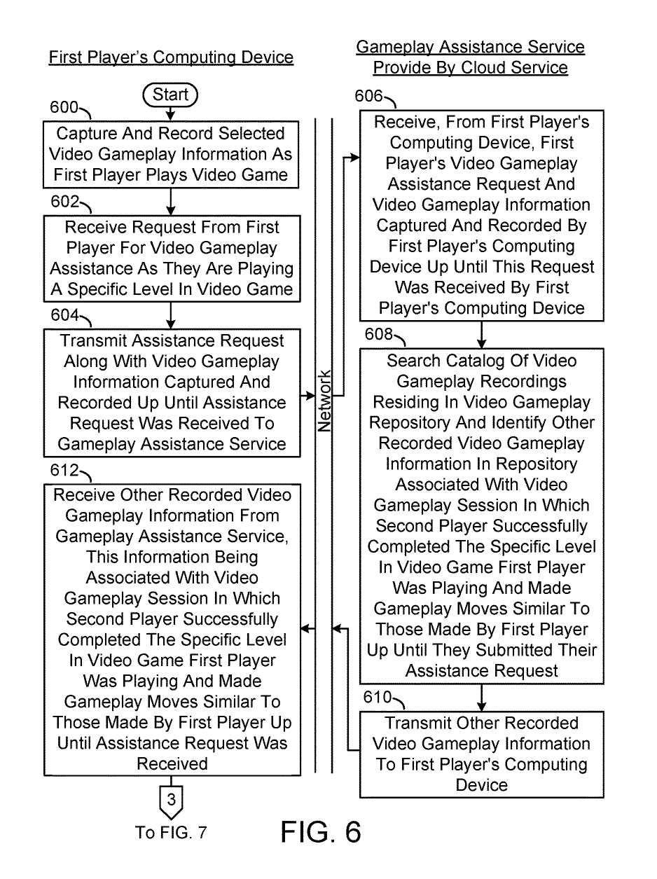

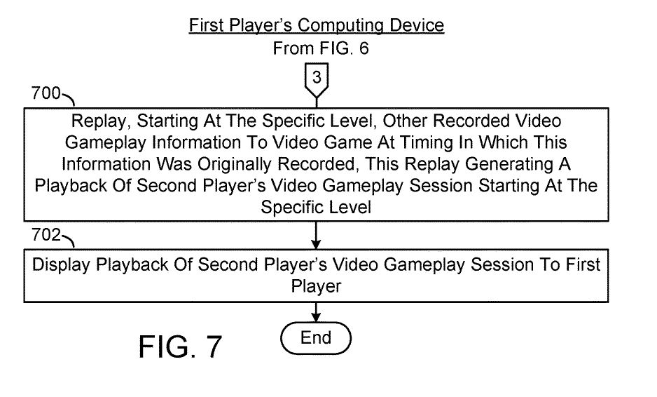

FIGS. 6 and 7 illustrate an exemplary implementation, in simplified form, of a process for providing video gameplay assistance over a computer network. In an exemplary implementation of the streaming technique described herein the process illustrated in FIGS. 6 and 7 is realized on the system framework 100 illustrated in FIG. 1. This process also assumes that a first player 102 is actively playing the video game 118 on their client computing device 104, and a second player (not shown) previously played the video game on their client computing device (not shown). As exemplified in FIG. 6, the process starts with the first player's computing device capturing and recording selected video gameplay information as the first player is playing the video game (process action 600). In an exemplary implementation of the streaming technique this recording action 600 includes relating the selected video gameplay information to selected timing information in the video game such as the current wall-clock time in the video gameplay, the current frame rate in the video gameplay, and the current frame count in the video gameplay. The video gameplay information that is captured and recorded includes just video gameplay data that introduces non-determinism during the video gameplay (various examples of such gameplay data have been described heretofore).

Referring again to FIG. 6 and as exemplified in FIG. 7, in the case where the first player gets stuck as they are playing a specific level in the video game and wants a hint regarding how to proceed past the point where they are stuck, the first player can be provided with a user interface that allows them to submit a request for video gameplay assistance as they are playing this specific level. Upon the first player's computing device receiving such a request (process action 602), the first player's computing device will transmit this request along with the video gameplay information that was captured and recorded up until this request was received over the network to the aforementioned gameplay assistance service that is provided by the cloud service (process action 604). Upon receiving the first player's request for video gameplay assistance and the video gameplay information that was captured and recorded by the first player's computing device up until this request was received by the first player's computing device (process action 606), the gameplay assistance service searches the catalog of video gameplay recordings that resides in the video gameplay repository and identifies other recorded video gameplay information in the repository that is associated with a video gameplay session in which a second player successfully completed the specific level in the video game that the first player was playing and made gameplay moves similar to the those made by the first player up until they submitted their request for video gameplay assistance (process action 608). The gameplay assistance service then transmits this other recorded video gameplay information over the network to the first player's computing device (process action 610). The first player's computing device then receives this other recorded video gameplay information from the gameplay assistance service (process action 612). In the case where the received other recorded video gameplay information is compressed, this reception action 612 includes decompressing the other recorded video gameplay information. Regardless of whether or not the received other recorded video gameplay information is compressed, since the amount of data associated with this information is significantly smaller than the amount of data associated with a video recording of the gameplay, actions 610 and 612 advantageously enhance the operation of the first player's computing device and the server computing devices by reducing network bandwidth usage and by providing faster communication between the first player's computing device and the server computing devices. Upon receiving the other recorded video gameplay information transmitted from the gameplay assistance service (action 612), the first player's computing device replays, starting at the aforementioned specific level, the other recorded video gameplay information to the video game at the timing in which the other recorded video gameplay information was originally recorded, where this replay generates a playback of the second player's video gameplay session starting at the specific level (process action 700). The first player's computing device then displays this playback on the display screen of the first player's computing device (process action 702). Given the foregoing, it will be appreciated that actions 700 and 702 serve to increase the first player's efficiency since these actions allow the first player to see how the second player accomplished the gameplay.

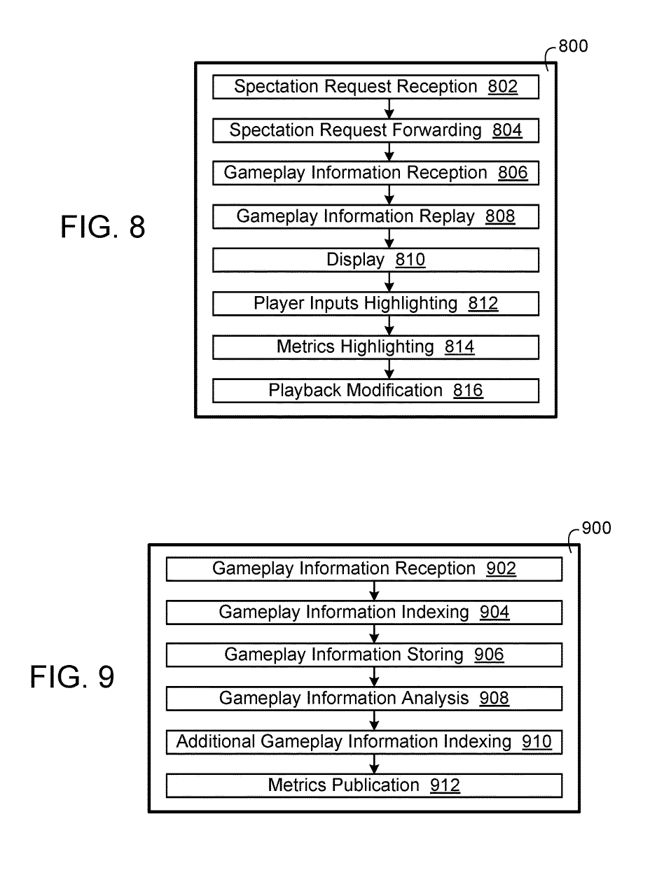

FIG. 8 illustrates an exemplary implementation, in simplified form, of a video gameplay replayer computer program for spectating video gameplay over a computer network. As exemplified in FIG. 8 and referring again to FIGS. 3-5, the video gameplay replayer computer program 800 includes, but is not limited to, a spectation request reception sub-program 802 that performs action 314, a spectation request forwarding sub-program 804 that performs action 316, a gameplay information reception sub-program 806 that performs action 402, a gameplay information replay sub-program 808 that performs action 404, a display sub-program 810 that performs action 406, a player inputs highlighting sub-program 812 that performs action 408, a metrics highlighting sub-program 814 that performs action 410, and a playback modification sub-program 816 that performs actions 500/502/504. Each of the just-described sub-programs is realized on a computing device such as that which is described in more detail in the Exemplary Operating Environments section which follows. More particularly and by way of example but not limitation, in one implementation of the streaming technique described herein the just-described sub-programs may all be realized on the spectator's computing device.

FIG. 9 illustrates an exemplary implementation, in simplified form, of a video gameplay cataloger computer program for cataloging video gameplay. As exemplified in FIG. 9 and referring again to FIG. 2, the video gameplay cataloger computer program 900 includes, but is not limited to, a gameplay information reception sub-program 902 that performs action 204, a gameplay information indexing sub-program 904 that performs action 206, a gameplay information storing sub-program 906 that performs action 208, a gameplay information analysis sub-program 908 that performs action 210, an additional gameplay information indexing sub-program 910 that performs action 212, and a metrics publication sub-program 912 that performs action 214. Each of the just-described sub-programs is realized on a computing device such as that which is described in more detail in the Exemplary Operating Environments section which follows. More particularly and by way of example but not limitation, in one implementation of the streaming technique described herein the just-described sub-programs may all be realized on the server computing devices upon which the cloud service operates.

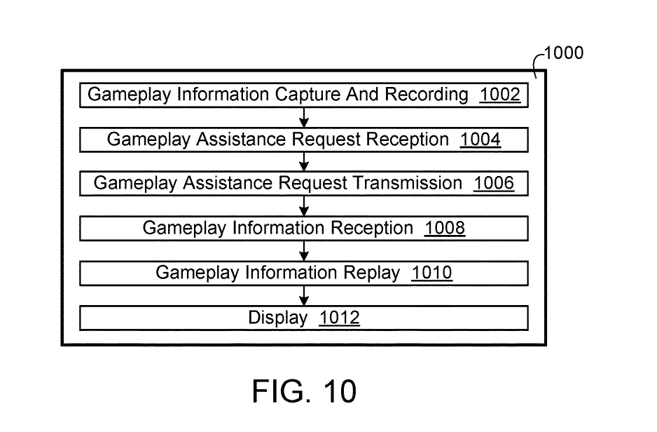

FIG. 10 illustrates an exemplary implementation, in simplified form, of a video gameplay assister computer program for providing video gameplay assistance over a computer network. As exemplified in FIG. 10 and referring again to FIGS. 6 and 7, the video gameplay assister computer program 1000 includes, but is not limited to, a gameplay information capture and recording sub-program 1002 that performs action 600, a gameplay assistance request reception sub-program 1004 that performs action 602, a gameplay assistance request transmission sub-program 1006 that performs action 604, a gameplay information reception sub-program 1008 that performs action 612, a gameplay information replay sub-program 1010 that performs action 700, and a display sub-program 1012 that performs action 702. Each of the just-described sub-programs is realized on a computing device such as that which is described in more detail in the Exemplary Operating Environments section which follows. More particularly and by way of example but not limitation, in one implementation of the streaming technique described herein the just-described sub-programs may all be realized on a player's computing device.

### 3.0 Other Implementations

While the streaming technique has been described by specific reference to implementations thereof, it is understood that variations and modifications thereof can be made without departing from the true spirit and scope of the streaming technique. By way of example but not limitation, rather than the recorded video gameplay information being transmitted from the player's computing device over the data communication network to the cloud service where it is stored and processed as described heretofore, and then from the cloud service over the network to the spectator's computing device, a peer-to-peer implementation of the streaming technique is possible where the recorded video gameplay information is stored on the player's computing device and then transmitted over the network directed to the spectator's computing device. A dual-replay implementation of the streaming technique is also possible where the spectator can replay two different video gameplay recordings at the same time (e.g., alongside each other) in order to compare the gameplay in each of the recordings.

A video generation implementation of the streaming technique described herein is also possible where, rather than the recorded video gameplay information being replayed to the video game on the spectator's computing device as described heretofore, the recorded video gameplay information is replayed to the video game by the cloud service, where this cloud service replay generates a video of the recorded video gameplay that may then be either transmitted to the client computing device of a given spectator, or stored in the video gameplay repository. When this video is generated by the cloud service the video can optionally include the aforementioned highlighting of the inputs the player made to the video game to control it during their gameplay. This video generation implementation of the streaming technique is advantageous in that will work on any type of client computing device that the spectator may be using, it does not require that this device run the video game or game engine, and the spectator can view the recorded video gameplay in a web browser.

Additionally, the streaming technique implementations described herein may be used by the developer (e.g., the owner) of a given video game to run a social media campaign that encourages users to play the video game in novel ways that may be of interest to other users, and to capture and record these new ways of playing the video game, without the video game developer having to modify the video game. The video game developer may then use the streaming technique implementations to post the recordings of these new ways of playing the video game on their social network. The video game developer may also use the streaming technique implementations to highlight specific ones of the gameplay performance metrics that are calculated for these recordings that make the video gameplay in the recordings novel and interesting.

It is noted that any or all of the aforementioned implementations throughout the description may be used in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 4.0 Exemplary Operating Environments

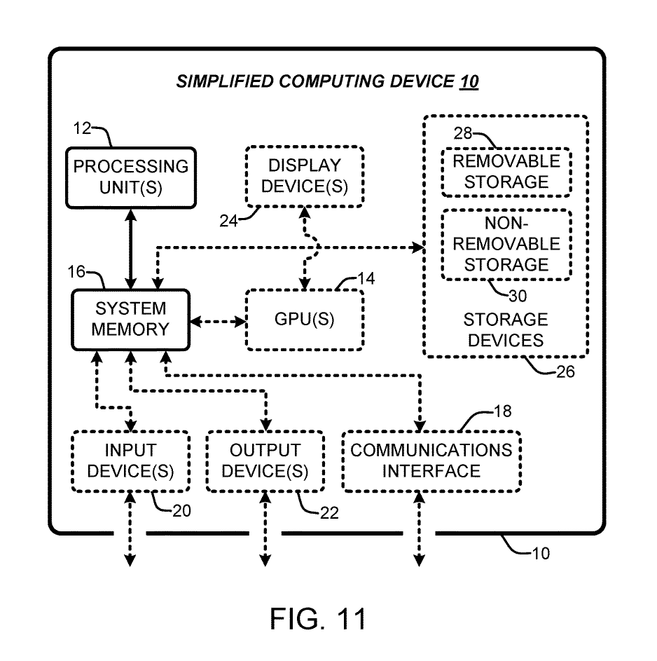

The streaming technique implementations described herein are operational within numerous types of general purpose or special purpose computing system environments or configurations. FIG. 11 illustrates a simplified example of a general-purpose computer system on which various implementations and elements of the streaming technique, as described herein, may be implemented. It is noted that any boxes that are represented by broken or dashed lines in the simplified computing device 10 shown in FIG. 11 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the streaming technique implementations described herein, the device should have a sufficient computational capability and system memory to enable basic computational operations. In particular, the computational capability of the simplified computing device 10 shown in FIG. 11 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the streaming technique implementations described herein, including input, output, control, feedback, and response to one or more users or other devices or systems associated with the streaming technique implementations, are enabled by a variety of Natural User Interface (NUI) scenarios. The NUI techniques and scenarios enabled by the streaming technique implementations include, but are not limited to, interface technologies that allow one or more users user to interact with the streaming technique implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the streaming technique implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the streaming technique implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 11 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various streaming technique implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The streaming technique implementations described herein may be further described in the general context of computer-executable instructions, such as program modules, being executed by a computing device. Generally, program modules include routines, programs, objects, components, data structures, and the like, that perform particular tasks or implement particular abstract data types. The streaming technique implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

### 5.0 Claim Support and Further Implementations

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

In one implementation a system is employed for spectating video gameplay over a computer network. This system includes a video gameplay replayer that includes a computing device used by a spectator. This spectator computing device includes a display screen and a video game executable by the spectator computing device. The video game includes a game engine. The spectator computing device further includes a computer program having a plurality of sub-programs also executable by the spectator computing device, the spectator computing device being directed by the sub-programs of the computer program to, receive a request from the spectator to spectate a selected video gameplay recording, this recording being of a player who was playing the video game, forward this spectation request over the network to a video gameplay repository, receive recorded video gameplay information associated with the recording over the network from the repository, this gameplay information comprising each of the high-level game commands that was input to the game engine as the player was playing the video game, and inputs the player made to the video game to control it as they were playing it, replay the gameplay information to the video game at the timing in which the gameplay information was originally recorded, this replay including replaying the high-level game commands to the game engine, the replay generating a playback of the recording, display this playback on the display screen, and upon receiving a request from the spectator to view the inputs the player made to the video game, highlight the inputs the player made to the video game on the display screen during the playback.

In one implementation of the just-described system the sub-program for receiving recorded video gameplay information associated with the recording over the network from the repository includes a sub-program for, whenever the received recorded video gameplay information is compressed, decompressing the received recorded video gameplay information. In another implementation, whenever the spectator is playing the video game at the time they submit the spectation request, the sub-program for replaying the gameplay information to the video game at the timing in which the gameplay information was originally recorded includes a sub-program for performing the replay in an isolated manner so that the current state of the gameplay of the spectator is not modified by the replay.

In another implementation the gameplay information further includes one or more of: the name of the video game; or the name of the player; or the level in the video game that the player started their gameplay in; or the level in the video game that the player finished their gameplay in; or the time duration of the gameplay of the player; or the total number of points awarded to the player during their gameplay; or other achievements awarded to the player during their gameplay; or the position in the video game where the player started their gameplay; or the position in the video game where the player finished their gameplay. In another implementation the gameplay information further includes one or more of: the current seeds to one or more random number generators employed in the video game; or the current wall-clock time; or the current frame count; or updates to movable objects in the video game that are device-performance-specific; or updates to movable objects in the video game that are time-specific; or updates to coroutines employed in the video game; or whenever the video game further includes a physics engine, updates to the physics engine.

In another implementation the sub-program for replaying the high-level game commands to the game engine includes sub-programs for: replaying certain ones of the high-level game commands to the game engine relative to the current wall-clock time from the gameplay information; replaying other ones of the high-level game commands to the game engine relative to the current frame count from the gameplay information; whenever the spectator computing device is either slower or faster than a computing device used by the player to play the video game, using prescribed elements of the gameplay information to adjust the speed of the replay; intercepting each random number generator call and providing the current seed to this generator from the gameplay information to the random number generator call; and intercepting each wall-clock time call and providing the current wall-clock time from the gameplay information to the wall-clock time call. In another implementation the gameplay information further includes one or more of: the current physical location of the player as they were playing the video game; or the resolution and aspect ratio of the display screen of a computing device used by the player to play the video game; or whenever this player computing device includes an audio input device, data from the audio input device as the player was playing the video game; or whenever the player computing device includes a video input device, data from the video input device as the player was playing the video game.

In another implementation a computing device used by the player to play the video game includes a file system, and the gameplay information further includes one of: each item of information that was read from the file system as the player was playing the video game; or each item of information that is both read from and written to the file system as the player was playing the video game; or just information related to files in the file system that are modified during the playing of the video game, these files being determined by an historical analysis of the file system. In another implementation, whenever the spectator is playing the video game at the time they submit the spectation request, the sub-program for displaying the playback on the display screen includes a one of the sub-programs for: displaying the playback in place of the video gameplay of the spectator; or displaying the playback as a semi-transparent overlay layer on top of the video gameplay of the spectator; or displaying the playback alongside of the video gameplay of the spectator. In another implementation the sub-program for displaying the playback as a semi-transparent overlay layer on top of the video gameplay of the spectator includes one or more of the sub-programs for: synchronizing the playback to the video gameplay of the spectator; or adapting the playback to the current point of view and viewing angle of the video gameplay of the spectator. In another implementation the sub-program for displaying the playback alongside of the video gameplay of the spectator includes one or more of the sub-programs for: synchronizing the playback to the video gameplay of the spectator; or adapting the playback to the current point of view and viewing angle of the video gameplay of the spectator.

In another implementation the inputs the player made to the video game include one or more of: touch gestures that the player made on the touch-sensitive display screen of a computing device used by the player to play the video game; or key presses that the player made on a physical keyboard connected to this computing device used by the player; or one or more of button presses, or joystick movements, or D-pad presses that the player made on a game controller connected to the computing device used by the player; or data from one or more motion sensors integrated into one or more of the computing device used by the player, or the physical keyboard, or the game controller; or data from a mouse or trackpad connected to the computing device used by the player. In another implementation the spectator computing device is further directed by the sub-programs of the computer program to: receive one or more gameplay performance metrics that were calculated for the recording over the network from the repository; and upon receiving a request from the spectator to view a selected one of these metrics, highlight the selected one of the metrics on the display screen during the playback. In another implementation the spectator computing device is further directed by the sub-programs of the computer program to, upon receiving a request from the spectator to change one or more of the point of view or viewing angle of the playback, modify the point of view and viewing angle of the playback accordingly.

The implementations described in any of the previous paragraphs in this section may also be combined with each other, and with one or more of the implementations and versions described prior to this section. For example, some or all of the preceding implementations and versions may be combined with the foregoing implementation where the gameplay information further includes one or more of: the name of the video game; or the name of the player; or the level in the video game that the player started their gameplay in; or the level in the video game that the player finished their gameplay in; or the time duration of the gameplay of the player; or the total number of points awarded to the player during their gameplay; or other achievements awarded to the player during their gameplay; or the position in the video game where the player started their gameplay; or the position in the video game where the player finished their gameplay. In addition, some or all of the preceding implementations and versions may be combined with the forgoing implementation where the gameplay information further includes one or more of: the current seeds to one or more random number generators employed in the video game; or the current wall-clock time; or the current frame count; or updates to movable objects in the video game that are device-performance-specific; or updates to movable objects in the video game that are time-specific; or updates to coroutines employed in the video game; or whenever the video game further includes a physics engine, updates to the physics engine.

In addition, some or all of the preceding implementations and versions may be combined with the forgoing implementation where the gameplay information further includes one or more of: the current physical location of the player as they were playing the video game; or the resolution and aspect ratio of the display screen of a computing device used by the player to play the video game; or whenever this player computing device includes an audio input device, data from the audio input device as the player was playing the video game; or whenever the player computing device includes a video input device, data from the video input device as the player was playing the video game. In addition, some or all of the preceding implementations and versions may be combined with the forgoing implementation where, whenever the spectator is playing the video game at the time they submit the spectation request, the sub-program for displaying the playback on the display screen includes a one of the sub-programs for: displaying the playback in place of the video gameplay of the spectator; or displaying the playback as a semi-transparent overlay layer on top of the video gameplay of the spectator; or displaying the playback alongside of the video gameplay of the spectator. In addition, some or all of the preceding implementations and versions may be combined with the forgoing implementation where the inputs the player made to the video game include one or more of: touch gestures that the player made on the touch-sensitive display screen of a computing device used by the player to play the video game; or key presses that the player made on a physical keyboard connected to this computing device used by the player; or one or more of button presses, or joystick movements, or D-pad presses that the player made on a game controller connected to the computing device used by the player; or data from one or more motion sensors integrated into one or more of the computing device used by the player, or the physical keyboard, or the game controller; or data from a mouse or trackpad connected to the computing device used by the player.

In another implementation a system is employed for cataloging video gameplay. This system includes a video gameplay cataloger that includes one or more computing devices, these computing devices being in communication with each other via a computer network whenever there is a plurality of computing devices, and a computer program having a plurality of sub-programs executable by the one or more computing devices. The one or more computing devices are directed by the sub-programs of the computer program to, receive video gameplay information that was captured and recorded as a player was playing a video game, this gameplay information including just video gameplay data that introduced non-determinism during the video gameplay, the gameplay information having been related to selected timing information in the video game during the capture and recording of the gameplay information, index the gameplay information using prescribed elements of the gameplay information, store the indexed gameplay information in a catalog of video gameplay recordings, analyze the indexed gameplay information to calculate one or more gameplay performance metrics that are not already tracked by the video game, and further index the gameplay information using these calculated gameplay performance metrics.

In one implementation of the just-described system the selected timing information in the video game includes: the current wall-clock time in the video gameplay; the current frame rate in the video gameplay; and the current frame count in the video gameplay. In another implementation the calculated gameplay performance metrics include one or more of: the number of swipes per prescribed unit of time the player made on the touch-sensitive display screen of a computing device used by the player to play the video game; or the number of enemy kills the player made per prescribed unit of time; or the number of adjunct gameplay moves the player made per prescribed unit of time; or certain types of gameplay moves that are difficult for the player to make; or certain ancillary factors that are related to the video gameplay. In another implementation the one or more computing devices are further directed by the sub-programs of the computer program to publicize the calculated gameplay performance metrics in one or more social networking websites for which the player is registered.

The implementations described in any of the previous paragraphs in this section may also be combined with each other, and with one or more of the implementations and versions described prior to this section. For example, some or all of the preceding implementations and versions may be combined with the foregoing implementation where the calculated gameplay performance metrics include one or more of: the number of swipes per prescribed unit of time the player made on the touch-sensitive display screen of a computing device used by the player to play the video game; or the number of enemy kills the player made per prescribed unit of time; or the number of adjunct gameplay moves the player made per prescribed unit of time; or certain types of gameplay moves that are difficult for the player to make; or certain ancillary factors that are related to the video gameplay.

In another implementation a system is employed for providing video gameplay assistance over a computer network. This system includes a video gameplay assister that includes a computing device used by a first player. This first player computing device includes a display screen and a video game executable by the first player computing device, and the video game includes a game engine. The first player computing device further includes a computer program having a plurality of sub-programs also executable by the first player computing device. The first player computing device is directed by the sub-programs of the computer program to, capture and record video gameplay information as the first player is playing the video game, this gameplay information including just video gameplay data that introduces non-determinism during the video gameplay, receive a request from the first player for video gameplay assistance as they are playing a specific level in the video game, transmit this request along with the video gameplay information that was captured and recorded up until the request was received over the network to a gameplay assistance service, receive other recorded video gameplay information over the network from the gameplay assistance service, the other recorded video gameplay information being associated with a video gameplay session in which a second player successfully completed this specific level and made gameplay moves similar to those made by the first player up until the request was received from the first player, the other recorded video gameplay information including each of the high-level game commands that was input to the game engine as the second player was playing the video game, replay, starting at the specific level, the other recorded video gameplay information to the video game at the timing in which the other recorded video gameplay information was originally recorded, this replay including replaying the high-level game commands to the game engine, the replay generating a playback of the video gameplay session starting at the specific level, and display this playback on the display screen.

In one implementation of the just-described system the other recorded video gameplay information further includes one or more of: the current seeds to one or more random number generators employed in the video game as the second player was playing it; or the current wall-clock time as the second player was playing the video game; or the current frame count as the second player was playing the video game; or device-performance-specific updates to movable objects in the video game as the second player was playing it; or time-specific updates to movable objects in the video game as the second player was playing it; or updates to coroutines employed in the video game as the second player was playing it; or whenever the video game further includes a physics engine, updates to the physics engine as the second player was playing the video game.

In another implementation a video gameplay spectation system is implemented by a means for spectating video gameplay over a computer network. The video gameplay spectation system includes a video gameplay replayer means that includes a computing device used by a spectator. This spectator computing device includes a display screen and a video game executable by the spectator computing device, the video game including a game engine. The spectator computing device further includes processors configured to, receive a request from the spectator to spectate a selected video gameplay recording, this recording being of a player who was playing the video game, forward this spectation request over the network to a video gameplay repository, receive recorded video gameplay information associated with the recording over the network from the repository, this gameplay information including each of the high-level game commands that was input to the game engine as the player was playing the video game, and inputs the player made to the video game to control it as they were playing it, replay the gameplay information to the video game at the timing in which the gameplay information was originally recorded, this replay including replaying the high-level game commands to the game engine, the replay generating a playback of the recording, display this playback on the display screen, and upon receiving a request from the spectator to view the inputs the player made to the video game, highlight the inputs the player made to the video game on the display screen during the playback.

In one version of the just-described video gameplay spectation system, whenever the spectator is playing the video game at the time they submit the spectation request replaying the gameplay information to the video game at the timing in which the gameplay information was originally recorded includes performing the replay in an isolated manner so that the current state of the gameplay of the spectator is not modified by the replay. In another version replaying the high-level game commands to the game engine includes: replaying certain ones of the high-level game commands to the game engine relative to the current wall-clock time from the gameplay information; replaying other ones of the high-level game commands to the game engine relative to the current frame count from the gameplay information; whenever the spectator computing device is either slower or faster than a computing device used by the player to play the video game, using prescribed elements of the gameplay information to adjust the speed of the replay; intercepting each random number generator call and providing the current seed to this generator from the gameplay information to the random number generator call; and intercepting each wall-clock time call and providing the current wall-clock time from the gameplay information to the wall-clock time call.

In another version, whenever the spectator is playing the video game at the time they submit the spectation request, displaying the playback on the display screen includes one of: displaying the playback in place of the video gameplay of the spectator; or displaying the playback as a semi-transparent overlay layer on top of the video gameplay of the spectator; or displaying the playback alongside of the video gameplay of the spectator. In another version displaying the playback as a semi-transparent overlay layer on top of the video gameplay of the spectator includes one or more of: synchronizing the playback to the video gameplay of the spectator; or adapting the playback to the current point of view and viewing angle of the video gameplay of the spectator. In another version, the processors are further configured to: receive one or more gameplay performance metrics that were calculated for the recording over the network from the repository; and upon receiving a request from the spectator to view a selected one of these metrics, highlight the selected one of the metrics on the display screen during the playback. In another version, the processors are further configured to, upon receiving a request from the spectator to change one or more of the point of view or viewing angle of the playback, modify the point of view and viewing angle of the playback accordingly.

In another implementation a cataloging system is implemented by a means for cataloging video gameplay. The cataloging system includes a video gameplay cataloger means that includes one or more computing devices, these computing devices being in communication with each other via a computer network whenever there is a plurality of computing devices, these computing devices including processors configured to, receive video gameplay information that was captured and recorded as a player was playing a video game, this gameplay information including just video gameplay data that introduced non-determinism during the video gameplay, the gameplay information having been related to selected timing information in the video game during the capture and recording of the gameplay information, index the gameplay information using prescribed elements of the gameplay information, store the indexed gameplay information in a catalog of video gameplay recordings, analyze the indexed gameplay information to calculate one or more gameplay performance metrics that are not already tracked by the video game, and further index the gameplay information using these calculated gameplay performance metrics.

In another implementation a video gameplay assistance system is implemented by a means for providing video gameplay assistance over a computer network. This video gameplay assistance system includes a video gameplay assister means that includes a computing device used by a first player, where this first player computing device includes a display screen and a video game executable by the first player computing device, the video game includes a game engine, and the first player computing device further includes processors configured to, capture and record video gameplay information as the first player is playing the video game, this gameplay information including just video gameplay data that introduces non-determinism during the video gameplay, receive a request from the first player for video gameplay assistance as they are playing a specific level in the video game, transmit this request along with the video gameplay information that was captured and recorded up until the request was received over the network to a gameplay assistance service, receive other recorded video gameplay information over the network from the gameplay assistance service, the other recorded video gameplay information being associated with a video gameplay session in which a second player successfully completed the specific level and made gameplay moves similar to those made by the first player up until the request was received from the first player, the other recorded video gameplay information including each of the high-level game commands that was input to the game engine as the second player was playing the video game, replay, starting at the specific level, the other recorded video gameplay information to the video game at the timing in which the other recorded video gameplay information was originally recorded, this replay including replaying the high-level game commands to the game engine, the replay generating a playback of the video gameplay session starting at the specific level, and display this playback on the display screen.

Wherefore, what is claimed is:

1. A system for spectating video gameplay over a computer network, comprising:
a video gameplay replayer comprising a computing device used by a spectator, said spectator computing device comprising a display screen and a video game executable by said spectator computing device, the video game comprising a game engine, said spectator computing device further comprising a computer program having a plurality of sub-programs also executable by said spectator computing device, said spectator computing device being directed by the sub-programs of the computer program to,
receive a request from the spectator to spectate a selected video gameplay recording, said recording being of a player who was playing the video game,
forward said spectation request over the network to a video gameplay repository,
receive recorded video gameplay information associated with said recording over the network from the repository, said gameplay information comprising each of the high-level game commands that was input to the game engine as the player was playing the video game, and inputs the player made to the video game to control it as they were playing it,
replay said gameplay information to the video game at the timing in which said gameplay information was originally recorded, said replay comprising replaying said high-level game commands to the game engine, said replay generating a playback of said recording,
display said playback on the display screen, and
upon receiving a request from the spectator to view said inputs the player made to the video game, highlight said inputs the player made to the video game on the display screen during said playback.

2. The system of claim 1, wherein the sub-program for receiving recorded video gameplay information associated with said recording over the network from the repository comprises a sub-program for, whenever the received recorded video gameplay information is compressed, decompressing the received recorded video gameplay information.

3. The system of claim 1, wherein, whenever the spectator is playing the video game at the time they submit said spectation request, the sub-program for replaying said gameplay information to the video game at the timing in which said gameplay information was originally recorded comprises a sub-program for performing said replay in an isolated manner so that the current state of the gameplay of the spectator is not modified by said replay.

4. The system of claim 1, wherein said gameplay information further comprises one or more of:
the name of the video game; or
the name of the player; or
the level in the video game that the player started their gameplay in; or
the level in the video game that the player finished their gameplay in; or
the time duration of the gameplay of the player; or
the total number of points awarded to the player during their gameplay; or
other achievements awarded to the player during their gameplay; or
the position in the video game where the player started their gameplay; or
the position in the video game where the player finished their gameplay.

5. The system of claim 1, wherein said gameplay information further comprises one or more of:
the current seeds to one or more random number generators employed in the video game; or
the current wall-clock time; or
the current frame count; or
updates to movable objects in the video game that are device-performance-specific; or
updates to movable objects in the video game that are time-specific; or
updates to coroutines employed in the video game; or
whenever the video game further comprises a physics engine, updates to the physics engine.

6. The system of claim 5, wherein the sub-program for replaying said high-level game commands to the game engine comprises sub-programs for:
replaying certain ones of said high-level game commands to the game engine relative to the current wall-clock time from said gameplay information;
replaying other ones of said high-level game commands to the game engine relative to the current frame count from said gameplay information;
whenever said spectator computing device is either slower or faster than a computing device used by the player to play the video game, using prescribed elements of said gameplay information to adjust the speed of said replay;
intercepting each random number generator call and providing the current seed to said generator from said gameplay information to the random number generator call; and
intercepting each wall-clock time call and providing the current wall-clock time from said gameplay information to the wall-clock time call.

7. The system of claim 1, wherein said gameplay information further comprises one or more of:
the current physical location of the player as they were playing the video game; or
the resolution and aspect ratio of the display screen of a computing device used by the player to play the video game; or
whenever said player computing device comprises an audio input device, data from the audio input device as the player was playing the video game; or
whenever said player computing device comprises a video input device, data from the video input device as the player was playing the video game.

8. The system of claim 1, wherein a computing device used by the player to play the video game comprises a file system, and said gameplay information further comprises one of:
each item of information that was read from the file system as the player was playing the video game; or
each item of information that is both read from and written to the file system as the player was playing the video game; or
just information related to files in the file system that are modified during the playing of the video game, said files being determined by an historical analysis of the file system.

9. The system of claim 1, wherein, whenever the spectator is playing the video game at the time they submit said spectation request, the sub-program for displaying said playback on the display screen comprises a one of the sub-programs for:
displaying said playback in place of the video gameplay of the spectator; or
displaying said playback as a semi-transparent overlay layer on top of the video gameplay of the spectator; or
displaying said playback alongside of the video gameplay of the spectator.

10. The system of claim 9, wherein the sub-program for displaying said playback as a semi-transparent overlay layer on top of the video gameplay of the spectator comprises one or more of the sub-programs for:
synchronizing said playback to the video gameplay of the spectator; or
adapting said playback to the current point of view and viewing angle of the video gameplay of the spectator.

11. The system of claim 9, wherein the sub-program for displaying said playback alongside of the video gameplay of the spectator comprises one or more of the sub-programs for:
synchronizing said playback to the video gameplay of the spectator; or
adapting said playback to the current point of view and viewing angle of the video gameplay of the spectator.

12. The system of claim 1, wherein said inputs the player made to the video game comprise one or more of:
touch gestures that the player made on the touch-sensitive display screen of a computing device used by the player to play the video game; or
key presses that the player made on a physical keyboard connected to said computing device used by the player; or
one or more of button presses, or joystick movements, or D-pad presses that the player made on a game controller connected to said computing device used by the player; or
data from one or more motion sensors integrated into one or more of said computing device used by the player, or said physical keyboard, or said game controller; or
data from a mouse or trackpad connected to said computing device used by the player.

13. The system of claim 1, wherein said spectator computing device is further directed by the sub-programs of the computer program to:
receive one or more gameplay performance metrics that were calculated for said recording over the network from the repository; and
upon receiving a request from the spectator to view a selected one of said metrics, highlight the selected one of said metrics on the display screen during said playback.

14. The system of claim 1, wherein said spectator computing device is further directed by the sub-programs of the computer program to, upon receiving a request from the spectator to change one or more of the point of view or viewing angle of said playback, modify the point of view and viewing angle of said playback accordingly.

15. A system for cataloging video gameplay, comprising:
a video gameplay cataloger comprising one or more computing devices, said computing devices being in communication with each other via a computer network whenever there is a plurality of computing devices, and a computer program having a plurality of sub-programs executable by the one or more computing devices, the one or more computing devices being directed by the sub-programs of the computer program to,
receive video gameplay information that was captured and recorded as a player was playing a video game, said gameplay information comprising just video gameplay data that introduced non-determinism during the video gameplay, said gameplay information having been related to selected timing information in the video game during the capture and recording of said gameplay information,
index said gameplay information using prescribed elements of said gameplay information,
store the indexed gameplay information in a catalog of video gameplay recordings,
analyze the indexed gameplay information to calculate one or more gameplay performance metrics that are not already tracked by the video game, and
further index said gameplay information using said calculated gameplay performance metrics.

16. The system of claim 15, wherein the selected timing information in the video game comprises:
the current wall-clock time in the video gameplay;
the current frame rate in the video gameplay; and
the current frame count in the video gameplay.

17. The system of claim 15, wherein said calculated gameplay performance metrics comprise one or more of:
the number of swipes per prescribed unit of time the player made on the touch-sensitive display screen of a computing device used by the player to play the video game; or
the number of enemy kills the player made per prescribed unit of time; or
the number of adjunct gameplay moves the player made per prescribed unit of time; or
certain types of gameplay moves that are difficult for the player to make; or
certain ancillary factors that are related to the video gameplay.

18. The system of claim 15, wherein the one or more computing devices are further directed by the sub-programs of the computer program to publicize said calculated gameplay performance metrics in one or more social networking websites for which the player is registered.

19. A system for providing video gameplay assistance over a computer network, comprising:
a video gameplay assister comprising a computing device used by a first player, said first player computing device comprising a display screen and a video game executable by said first player computing device, the video game comprising a game engine, said first player computing device further comprising a computer program having a plurality of sub-programs also executable by said first player computing device, said first player computing device being directed by the sub-programs of the computer program to,
capture and record video gameplay information as the first player is playing the video game, said gameplay information comprising just video gameplay data that introduces non-determinism during the video gameplay,
receive a request from the first player for video gameplay assistance as they are playing a specific level in the video game,
transmit said request along with the video gameplay information that was captured and recorded up until said request was received over the network to a gameplay assistance service,
receive other recorded video gameplay information over the network from the gameplay assistance service, the other recorded video gameplay information being associated with a video gameplay session in which a second player successfully completed said specific level and made gameplay moves similar to those made by the first player up until said request was received from the first player, the other recorded video gameplay information comprising each of the high-level game commands that was input to the game engine as the second player was playing the video game,
replay, starting at said specific level, the other recorded video gameplay information to the video game at the timing in which the other recorded video gameplay information was originally recorded, said replay comprising replaying said high-level game commands to the game engine, said replay generating a playback of said video gameplay session starting at said specific level, and
display said playback on the display screen.

20. The system of claim 19, wherein the other recorded video gameplay information further comprises one or more of:
the current seeds to one or more random number generators employed in the video game as the second player was playing it; or
the current wall-clock time as the second player was playing the video game; or
the current frame count as the second player was playing the video game; or
device-performance-specific updates to movable objects in the video game as the second player was playing it; or
time-specific updates to movable objects in the video game as the second player was playing it; or
updates to coroutines employed in the video game as the second player was playing it; or
whenever the video game further comprises a physics engine, updates to the physics engine as the second player was playing the video game.
